(19) United States
(12) Patent Application Publication
(10) Pub. No.: US 2017/0098358 A1
(43) Pub. Date: Apr. 6, 2017

(54) GENERATING INFORMATIVE ALARM NOTIFICATIONS TO IDENTIFY PATIENT NEED AND DATA QUALITY

(71) Applicant: CERNER INNOVATION, INC., KANSAS CITY, KS (US)

(72) Inventors: TODD BECHTEL, Overland Park, KS (US); ELIZABETH FAY OSBORNE, Kansas City, MO (US); SASANKA ARE, Kansas City, MO (US); SCOTT GORDON SIEBERS, Leawood, KS (US); JASON ANDREW KOMAREK, Kearney, MO (US)

(21) Appl. No.: 14/872,866

(22) Filed: Oct. 1, 2015

(51) Int. Cl. G08B 21/02; G06F 3/0484

(52) U.S. Cl. CPC G08B 21/02; G06F 3/04842

(57) ABSTRACT

Methods and graphical user interfaces are provided for generating alarm notifications. For each of a plurality of patients, an alarm hotspot may be detected in near-real time. An alarm hotspot is detected using indications of alarms issued by devices that monitor a patient in a hospital setting. Once detected, the alarm hotspot is analyzed, in near-real time, so as to identify that one or more interventions are available for performance by a clinician. An action may include a clinician changing a lead, tuning a monitor limit, undertaking an intervention that addresses a physiological or non-physiological aspect of the patient that triggered an alarm, or a combination thereof. Then, alarm hotspot information and the identified action are communicated to a clinician in near-real time using an easily consumable notification.

### BACKGROUND

In a hospital setting, clinicians face a veritably unceasing barrage of alarm notifications emitted by myriad devices configured to trigger an alarm when a patient's physiological or non-physiological measurements and/or readings change. A shrill cacophony of chirps, beeps, pings, rings, and the like may audibly pollute a hospital floor, and any number of electronic notifications may clutter a clinician's workspace (e.g., computer display screen for managing patients). A clinician is responsible for addressing each and every alarm notification received for each patient under their care, for instance, on the clinician's floor, within the clinician's unit, or to which the clinician has been assigned. As a clinician becomes responsible for more and more patients, and as each patient may have several simultaneous alarms issue, the alarm noise and workload created for addressing each alarm creates a burdensome and stressful environment for a clinician. Further still, as health-care monitoring technology progresses, more and more physiological and non-physiological aspects may be monitored, resulting in an ever-growing number of alarms that may be triggered for each patient under a clinician's care.

Although current alarm devices exist, deficiencies remain and risks have been created. Clinicians may need to repetitively silence alarms that are deemed to be non-urgent in nature, are triggered by a reading of very poor quality (e.g., a bad lead is present that needs to be changed), or where the specific, but normal, characteristics of a patient are outside defined parameters set for the alarm. Such factory-defined parameters for triggering an alarm may not be known or readily visible to a clinician. Worse still, a clinician might simply silence a repetitive alarm to abate the nuisance created thereby. The noisy environment created by unrelenting alarms is distracting to clinicians, decreases the peaceful quality of a patients stay, and further, may result in a clinician disregarding repetitively triggered alarms as unimportant or “false” in nature (e.g., the-boy-who-cried-wolf). Such an environment reduces the productivity and morale of clinicians while negatively impacting patient care and recovery. True emergencies that arise amidst a symphony of repetitive alarms may be missed or overlooked by clinicians resulting in patient harm.

Although at least some of these problems are well known, an effective solution has not been proposed or implemented, as set forth hereinafter.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims.

In brief and at a high level, this disclosure describes, among other things, methods, systems, and computer-readable media for generating informative alarm notifications to identify patient need and data quality.

As will be described, alarm hotspots are detected and analyzed, and an alarm notification is communicated to clinicians in real time or near-real time. An alarm hotspot may indicate a real or true clinical need, for example, that a clinician may need to administer a therapeutic agent to a patient. An alarm hotspot may also be generated when an alarm limit that is inappropriately set for a particular patient's normal condition, for example, a patient who experiences chronic high blood pressure may continually trigger an alarm having a setting for a normal blood pressure reading, in some embodiments. In embodiments, an alarm hotspot may be generated when an alarm limit is inappropriately set for a patient's current condition, for example, an alarm having a setting for a normal blood pressure reading may be triggered regularly when a patient is treated with a medication that artificially elevates the patient's blood pressure. In another embodiment, an alarm hotspot may be generated by low quality data that is collected by a medical device, for example, poor lead placement on a patient may generate low quality data that triggers an alarm.

Information and indicators of alarms are received from a device, such as a medical monitoring device, continually or periodically. The indicators of alarms may be collected and/or accumulated over a time of time, for example, 15 minutes, 30 minutes, or one hour. The indicators of the alarms during the accumulation time period may then be analyzed in an effort to identify an alarm hotspot. When an alarm hotspot is identified, an indication of the alarm hotspot and information regarding the alarm hotspot may be communicated to a clinician via a computing device, such a laptop, mobile phone, or pager, for example.

Actions undertaken as a result of being informed of an alarm hotspot may reduce the amount of audible noise, improve alarm issuance quality, provide valuable patient and alarm information to a clinician in real time or near-real time In particular, this indication demonstrates something is “out of band”—requiring a clinician's attention or intervention. For example, an alarm notification may provide a visual at-a-glance alarm hotspot summary and related contextual information (e.g., alarm history and projected alarm behavior) to a clinician. Detailed, intelligent, and dynamic analysis of one or more alarm hotspots, performed in near-real time, can help identify and distinguish those alarms that result from poor quality data (e.g., data from a lead that may need to be changed), alarms that result from an alarm limit that is not appropriate to a particular patient's profile (e.g., a factory-set alarm trigger limit is too low or too high for a current patient's baseline or normal reading), and alarms that indicate a true need for intervention and clinician action, for example. A notification (e.g., visual or audible) of an alarm hotspot may have been caused by the quality of data received from a monitoring device, a preference or need to modify an alarm limit of a specific monitoring device, a dynamic and intelligent determination of a suggested alarm limit to be provided to a clinician, and other actions to be undertaken by a clinician such as patient intervention.

Alarm hotspots may be analyzed in real time to determine the quality of the data triggering an alarm, to assess the urgency of an alarm, to identify an action that a clinician may undertake in response to the alarm, to provide a direction to a clinician, or to suggest actions that a clinician may undertake based on the analysis. An alarm hotspot generally refers to one or more alarms triggered and issued by a patient-monitoring device within a specified or defined period of time. An alarm hotspot is identified by analysis of alarms, and may reflect the number of different alarms that occur, the number of occurrences of the same alarm, a severity of one or more alarms, a frequency of triggering of one or more alarms, a combination of specific alarms occurring together or close in time, and any number of other alarm factors and/or a combination thereof.

An alarm notification of an alarm hotspot may provide any of these information aspects immediately (e.g., a visualization may provide at-a-glance information regarding an alarm hotspot and/or an audible tone may provide immediate recognition of an alarm hotspot) or in response to a user request to provide additional detailed information based on informational importance and/or user preferences. Accordingly, a clinician may easily and efficiently monitor and manage a plurality of patients and corresponding monitoring device alarms of each patient in order to increase and/or maximize alarm efficacy by reducing “false” alarms resulting from poor data quality, decreasing repetitive alarms produced from inappropriate limits or thresholds, and further, improving the clinician work environment and patients stays by reducing noise levels.

### BRIEF DESCRIPTION OF THE DRAWINGS

Embodiments are described in detail below with reference to the attached drawings figures, wherein:

FIG. 1 is a block diagram of an exemplary computing system suitable to implement embodiments of the present invention;

FIG. 2 is a flow diagram showing a method for generating visual alarm notifications at a clinician endpoint in real time in accordance with an embodiment of the present invention;

FIG. 3 depicts an exemplary graphical user interface (GUI) that displays a visual notification of alarms in accordance with embodiments of the present invention;

FIG. 4 depicts an exemplary GUI that displays a visual notification of alarms in accordance with embodiments of the present invention;

FIG. 5 depicts an exemplary GUI that displays a visual notification of alarms in accordance with embodiments of the present invention;

FIG. 6 depicts a detail of an exemplary GUI for generating visual alarm notifications at a clinician endpoint in accordance with embodiments of the present invention;

FIG. 7 depicts a detail of an exemplary GUI for generating visual alarm notifications at a clinician endpoint in accordance with embodiments of the present invention;

FIG. 8 depicts a detail of an exemplary GUI for generating visual alarm notifications at a clinician endpoint in accordance with embodiments of the present invention;

FIG. 9 depicts a detail of an exemplary GUI for generating visual alarm notifications at a clinician endpoint in accordance with embodiments of the present invention;

FIG. 10 depicts an exemplary GUI that displays a visual notification of alarms in accordance with embodiments of the present invention;

FIG. 11 depicts an exemplary GUI that displays a visual notification of alarms in accordance with embodiments of the present invention;

FIG. 12 depicts a portion of an exemplary GUI for generating visual alarm notifications at a clinician endpoint in accordance with embodiments of the present invention;

FIG. 13 depicts an exemplary GUI for generating visual alarm notifications at a clinician endpoint in accordance with embodiments of the present invention;

FIG. 14 depicts a detail of an exemplary GUI for generating visual alarm notifications at a clinician endpoint in accordance with embodiments of the present invention; and

FIG. 15 depicts a detail of an exemplary GUI for generating visual alarm notifications at a clinician endpoint in accordance with embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

A first aspect is directed to a computer-implemented method for generating alarm notifications at a clinician endpoint in real time. The method includes, for each of a plurality of patients, detecting an alarm hotspot that includes one or more indications of an alarm issuance. Alarm issuances that occur over a time interval, such as 15, 30 or 60 minutes, may be documented and analyzed in near-real time to determine when an alarm hotspot is present. Alarm issuances may be further be aggregated over a series of time intervals and analyzed periodically. For example, an analysis may be performed every fifteen minutes to detect alarm hotspots. In a further example, an analysis may be performed every fifteen minutes and every hour on the hour to detect alarm hotspots.

When detected, the hotspot often leads to an action required of a clinician such as changing a lead, tuning a parameter limit, clinical intervention, or a combination thereof. In aspects, a notification of the alarm hotspot and the action are communicated in near-real time to the clinician.

A second aspect is directed to a graphical user interface (GUI) presenting a unit-level clinician dashboard with visual alarm notifications for a plurality of patients. In aspects, the GUI includes a dashboard view presenting patient care information for a plurality of patients. The dashboard view includes at least one column having a real-time alarm notification that provides an indication of monitor alarm issuances specific to a first monitor, in aspects. The first monitor may be specific to a physiological measurement of the patient. In aspects, the real-time alarm notification is automatically updated to present the indication of monitor alarm issuances and whether the monitor alarm issuances are determined to be an alarm hotspot.

A third aspect is directed to a graphical user interface (GUI) for presenting a clinician with visual alarm notifications for a plurality of patients. In aspects, the GUI generates and presents a clinician-specific patient-list view presenting patient care information for a plurality of patients monitored by the clinician. The GUI further includes, in aspects, at least one column having a real-time alarm notification that indicates a monitoring device alarm issuance specific to a first monitoring device, wherein the first monitoring device may be specific to a physiological measurement, wherein the real-time alarm notification is automatically updated. And when it is determined that the monitoring device alarm issuance specific to the first monitoring device qualifies as an alarm hotspot, a real-time alarm notification that indicates the alarm hotspot is automatically generated for presentation to the clinician in the at least one column, in aspects.

A fourth aspect is directed to a graphical user interface (GUI) for presenting alarm visualizations to a clinician in real time regarding a plurality of patients. In aspects, the GUI includes a plurality of cells, each cell including a location indicator and a patient indicator, each cell being specific to one patient that corresponds to the patient indicator, the patient being assigned to the same medical unit. When a determination of an alarm hotspot is made regarding the patient, the cell corresponding to the patient further includes an alarm hotspot visualization representing at least one monitor alarm issuance specific to the patient, wherein the alarm hotspot visualization is a representation of a timeline of the alarm hotspot or a representation of a most recent time interval of the alarm hotspot, in aspects.

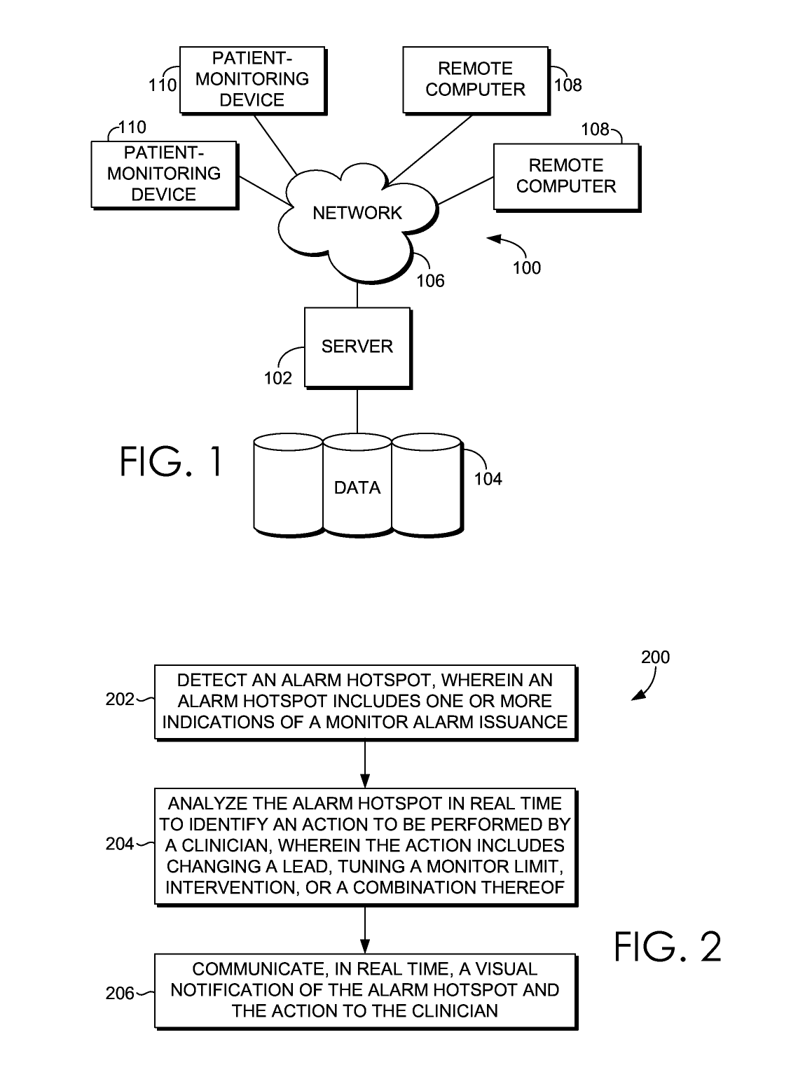

Referring to the drawings in general, and initially to FIG. 1 in particular, an exemplary computing system environment, for instance, a medical information computing system, on which embodiments of the present invention may be implemented is illustrated and designated generally as reference numeral 100. It will be understood and appreciated by those of ordinary skill in the art that the illustrated medical information computing system environment 100 is merely an example of one suitable computing environment and is not intended to suggest any limitation as to the scope of use or functionality of the invention. Neither should the medical information computing system environment 100 be interpreted as having any dependency or requirement relating to any single component or combination of components illustrated therein.

The present invention may be operational with numerous other general-purpose or special-purpose computing system environments or configurations. Examples of well-known computing systems, environments, and/or configurations that may be suitable for use with the present invention include, by way of example only, personal computers, server computers, handheld or laptop devices, multiprocessor systems, microprocessor-based systems, set top boxes, programmable consumer electronics, network PCs, minicomputers, mainframe computers, distributed computing environments that include any of the above-mentioned systems or devices, and the like. In embodiments, the present invention may be implemented in computing system environments employed within health care facilities, such as a distributed network that communicatively coupled multiple, affiliated hospitals and/or related out-patient clinics. For example, computing systems employed for health care facility implementation may include, in addition to those examples of well-known computing systems, patient monitoring devices, infusion pumps, ventilators, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary medical information computing system environment 100 includes a general-purpose computing device in the form of a server 102. Components of the server 102 may include, without limitation, a processing unit, internal system memory, and a suitable system bus for coupling various system components, including database cluster 104, with the server 102. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server 102 typically includes, or has access to, a variety of computer-readable media, for instance, database cluster 104. Computer-readable media can be any available media that may be accessed by server 102, and includes volatile and nonvolatile media, as well as removable and non-removable media. By way of example, and not limitation, computer-readable media may include computer storage media and communication media. Computer storage media may include, without limitation, volatile and nonvolatile media, as well as removable and non-removable media, implemented in any method or technology for storage of information, such as computer-readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the server 102. Computer storage media does not comprise signals per se. Communication media typically embodies computer-readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

The computer storage media discussed above and illustrated in FIG. 1, including database cluster 104, provides storage of computer-readable instructions, data structures, program modules, and other data for the server 102.

The server 102 may operate in a computer network 106 using logical connections to one or more remote computers 108. Remote computers 108 may be located at a variety of locations in a medical or research environment, for example, but not limited to, clinical laboratories, hospitals and other inpatient settings, veterinary environments, ambulatory settings, medical billing and financial offices, hospital administration settings, home health-care environments, and clinicians' offices. Clinicians may include, but are not limited to, a treating physician or physicians; specialists such as surgeons, radiologists, cardiologists, and oncologists; emergency medical technicians; physicians' assistants; nurse practitioners; nurses; nurses' aides; pharmacists; dieticians; microbiologists; laboratory experts; genetic counselors; researchers; veterinarians; students; and the like. The remote computers 108 may also be physically located in non-traditional medical care environments so that the entire health-care community may be capable of integration on the network. The remote computers 108 may be personal computers, servers, routers, network PCs, peer devices, other common network nodes, or the like, and may include some or all of the components described above in relation to the server 102. The devices can be personal digital assistants or other like devices.

The server 102, the remote computers 108, or other computing components may be communicatively coupled to patient-monitoring or medical devices. Exemplary patient-monitoring devices and medical devices may be configured to monitor physiological and/or non-physiological characteristics of a patient. Some examples of physiological characteristics include peripheral capillary oxygen saturation (SPO2), arterial line (ART), premature ventricular contractions (PVC), ventilator alarm, heart rate, respiratory rate, interictal spikes, waveform frequency of brainwaves, feeding pump, intravenous (IV) pump, and the like. Exemplary patient-monitoring devices and medical devices may be configured to monitor other aspects of patient care that are non-physiological in nature, such as an incline of a hospital bed or patient movement. A patient-monitoring device or medical device, as used herein, is capable of issuing an alarm notification based on a physiological or non-physiological reading, measurement, and/or a change in said reading and/or measurement that is relevant to patient care. The alarm notification may be an audible beep that is configured to garner attention. For example, an alarm notification may consist of repeating, audible beeps that continue to issue until a clinician manually addresses the device, alarm, or the like (e.g., pressing a mute button on the physical device or engaging a computer screen pop-up button notification).

In embodiments, a source, such as a patient-monitoring device or medical device, generates alarms, the generation of which may be determined by or influence by settings derived by the manufacturer, organization, or a clinician. For example, the alarm notification may be triggered and/or issued when a monitored characteristic of a patient changes (e.g., a sudden change in heart rate is detected), meets a threshold (e.g., a patient's heart rate meets a predetermined threshold or a clinician-set threshold of 100 beats per minute that is indicative of tachycardia), exceeds a threshold (e.g., a patient with an IV line placed at their upper hand bends their wrist which results in a high pressure reading on an IV pump), drops below a threshold, is outside of a range, is within a range, is close to a threshold, is within a range of a threshold (e.g., a respiratory rate is approaching a threshold indicative of respiratory distress), or is within a neighboring range (e.g., a patient's SPO2 reading is approaching a lower limit, such as 80%, that is indicative of organ impairment). Such a threshold and/or range, including upper and lower limits, might be factory-set and/or proprietary in nature such that a clinician may not know whether a particular reading may trigger an alarm unless and/or until an alarm is triggered and issued. Further, a threshold and/or range might be set by professional medical guidelines, clinical protocol, or clinical trial protocol. For example, a patient-monitoring device might measure or receive a blood pressure reading periodically, intermittently, or continuously, automatically and/or on command. The characteristics set forth herein are examples only and should not be construed as limiting in any way. And the descriptions of characteristics described are illustrative in nature and should not be construed as limiting as other aspects are considered to be within the scope of the invention due to advanced or specialized monitoring needs. The patient-monitoring devices may communicate an alarm and/or triggering information to the remote computing devices 108, the server 102, or other computing components in an effort to notify a clinician of the alarm. Communication may be hard-wired (e.g., coaxial, fiber optic cable) or wireless (e.g., Bluetooth, Wi-Fi, radio-frequency), in aspects.

Continuing, exemplary computer networks 106 may include, without limitation, local area networks (LANs) and/or wide area networks (WANs). Such networking environments are commonplace in offices, enterprise-wide computer networks, intranets, and the Internet. When utilized in a WAN networking environment, the server 102 may include a modem or other means for establishing communications over the WAN, such as the Internet. In a networked environment, program modules or portions thereof may be stored in the server 102, in the database cluster 104, or on any of the remote computers 108. For example, and not by way of limitation, various application programs may reside on the memory associated with any one or more of the remote computers 108. It will be appreciated by those of ordinary skill in the art that the network connections shown are exemplary and other means of establishing a communications link between the computers (e.g., server 102 and remote computers 108) may be utilized.

In operation, a user may enter commands and information into the server 102 or convey the commands and information to the server 102 via one or more of the remote computers 108 through input devices, such as a keyboard, a pointing device (commonly referred to as a mouse), a trackball, or a touch pad. In some embodiments, the user may enter input or command into a patient-monitoring device or medical device that is communicatively connected to a network of a health care facility or health care system. Other input devices may include, without limitation, microphones, satellite dishes, scanners, or the like. Commands and information may also be sent directly from a remote health-care device to the server 102. In addition to a monitor, the server 102 and/or remote computers 108 may include other peripheral output devices, such as speakers and a printer.

Although many other internal components of the server 102 and the remote computers 108 are not shown, those of ordinary skill in the art will appreciate that such components and their interconnection are well known. Accordingly, additional details concerning the internal construction of the server 102 and the remote computers 108 are not further disclosed herein.

Turning to FIG. 2, a flow diagram is provided illustrating a method 200 for generating alarm notifications at a clinician endpoint, in accordance with an embodiment of the present invention. The method 200 described may be performed in near-real time for each of a plurality of patients. As used herein, real time and near-real time may include latency that is commonly experienced by users interacting with computing devices, computing systems and networks. Initially, at block 202, an alarm hotspot is detected in near-real time, albeit may have a pre-defined delay in order to accumulate appropriate alarm data. An alarm hotspot includes one or more indications of monitor alarm issuances. The monitor alarm issuances may be determined to qualify as a hotspot. An alarm hotspot may be detected in near real time for a patient. An alarm hotspot may be determined based on the device and/or the characteristics being monitoring and/or measured (e.g., SPO2, PVC). Accordingly, an alarm hotspot may be device-specific, physiological-trait specific, non-physiological in nature, or alarm specific.

In aspects, the alarm hotspot is determined using a time interval or aggregation period. The terms time interval and aggregation period are used interchangeably herein. In some aspects, the time interval or aggregation period might be one minute, one hour, two hours, five and a half hours, one day, three days, or a week, for example. The time interval or aggregation period might be defined as including the time from a first alarm issuance through one subsequent minute, or might be defined as including the time from the issuance of a fifth alarm within thirty minutes until two subsequent hours, for example. The time interval or aggregation period might be defined as starting at the beginning of an hour, such as 7:00 a.m., 12:00 p.m., 4:00 p.m., 9:00 p.m., etc., and ending at the beginning of the subsequent hour, such as 8:00 a.m., 1:00 p.m., 5:00 p.m., and 10:00 p.m., etc., in some aspects. The time interval or aggregation period might correspond to a clinician's work shift, in some aspects.

In aspects, the alarm hotspot is determined relative to a time interval or an aggregation period. Information and data obtained, collected, received, or accumulated during the aggregation period may therefore be used when determining whether there may be an alarm hotspot. In some aspects, the time interval or aggregation period might be one minute, one hour, two hours, five and a half hours, one day, three days, or a week, for example. The time interval or aggregation period might be defined as including the time from a first alarm issuance through one subsequent minute, or might be defined as including the time from the issuance of a fifth alarm within 30 minutes until two subsequent hours, for example. The time interval or aggregation period might be defined as starting at the beginning of an hour, such as 7:00 a.m., 12:00 p.m., 4:00 p.m., 9:00 p.m., etc., and ending at the beginning of the subsequent hour, such as 8:00 a.m., 1:00 p.m., 5:00 p.m., and 10:00 p.m., etc., in some aspects. The time interval might correspond to a clinician's work shift, in some aspects. In other aspects, the time interval or aggregation period may be defined by the type of device from which information is to be received. For example, a one hour time aggregation period may be used for detecting an alarm hotspot for a first device whereas a 20 minute aggregation period may be used for detecting an alarm hotspot for a different second device. The time interval may be predetermined, preset, manually set, or dynamically defined using intelligent learning from information received from a monitoring device, for example. The examples set forth herein are merely illustrative in nature and should not be construed as limiting. The time interval may be predetermined, preset, manually set, or dynamically defined using intelligent learning from information received from a monitoring device, for example. The examples set forth herein are merely illustrative in nature and should not be construed as limiting.

In further aspects, the alarm hotspot may be determined by one or more factors. Exemplary factors might include an aggregated number of different alarm issuances (e.g., volume) for one patient; a number of alarm issuances for one specific monitoring device of one patient; the number of aggregated alarm issuances within a defined time interval (e.g., frequency) for one patient; the number of alarm issuances for one specific monitoring device within a defined time interval (e.g., frequency) for one patient; the severity of an alarm trigger (e.g., a very high heart rate measurement may result in a single, first alarm issuance) for one patient; an unusual or unlikely alarm trigger (e.g., an SPO2 reading of zero may indicate the monitoring device has insufficient contact for a proper reading of SPO2); or a combination thereof. Another factor examined may be alarm acceleration. Alarm acceleration refers to a detectable increase in the number of alarm issuances and an increase in frequency of alarm issuances that indicate an increased likelihood of alarm issuances. For example, alarm acceleration may be detected where four tachycardia alarms issue for a patient over the previous hour and only one tachycardia alarm has previously issued for the patient in the 24 hours prior to the previous hour. In another example, alarm acceleration might be detected where twelve different (or distinguishable) alarms have issued for a patient in the previous four hours where a total of three alarms (whether the same or different) have issued for the patient in the previous twelve hours. In further aspects, an alarm hotspot may be determined based on any or all of previously mentioned factors, alarm acceleration, or both. In aspects, an alarm hotspot may be determined for one or more alarms and for one or more patients in real time.

The alarm hotspot is analyzed in near-real time to identify an action to be performed by a clinician at block 204. Accordingly, an alarm hotspot may be brought to the attention of a clinician throughout the day, as events unfold. The analysis may examine a plurality of alarm hotspot factors, may statistically weight factors, may determine one or more relationships between factors (e.g., proportional, inversely proportional), may determine a ratio of a first factor to a second factor, and/or identify one or more factors that are the most pertinent to the alarm hotspot analysis, for example. Based on the analysis, the alarm hotspot provides an indication, or is itself an indication, that one or more interventions are available to a clinician for addressing at least one alarm corresponding to the alarm hotspot. For example, interventions may include a clinician action. The action may be a recommendation that a clinician perform a particular task, a suggestion to aid a clinician in troubleshooting a repetitive alarm, a directive or instruction that the clinician perform a task, or a combination thereof. The action may be indicated as required, urgent, high, medium, low, as-needed basis (e.g., pro re nata (PRN)), or may include another indication of priority, or none at all, for example. The action generally includes a recommendation for a clinician to change a lead, tune a monitor limit, undertake a clinical intervention or therapeutic intervention regarding a patient, or a combination thereof. One or more actions may be indicated to a clinician, alone, together in combination, and/or in a sequence. As described, an action to be performed refers to an action that a clinician is directed to undertake that addresses or responds to an alarm and/or the alarm hotspot.

Changing a lead generally refers to replacing an electrode that is placed on a patient (e.g., placed on the outer skin surface, implanted under the skin, or otherwise inserted into the patient's muscle or organ tissue) for measuring electrical changes that are indicative of physiological characteristics of the patient. Commonly, up to ten leads are strategically and purposefully placed at a plurality of locations upon a patient's skin in order to measure electrical changes that indicate the patient's heart rate, for example. In yet another example, leads are placed on a patient's scalp to measure electrical changes indicative of potential epileptic events. A lead (e.g., electrode) that is indicated to be changed may be malfunctioning due to manufacturing defects, poor or improper placement on the patient, damage, use, and/or wear. Further, an action including changing a lead may incorporate a clinical protocol in addition to or in combination with mere replacement of the lead itself. For instance, changing a lead may further include a protocol that indicates removing the existing lead, cleansing a corresponding portion of the patient's skin with warm soapy water, drying the portion of skin, and applying a new lead at the corresponding location. The protocol may be defined by current practice definitions, professional organization standards, and/or hospital-defined practices.

Tuning a monitor limit generally refers to manually or electronically modifying a limit or threshold that defines one or more triggering points of an alarm of a monitoring device. Tuning refers to an adjustment that improves overall performance of the monitoring device and an alarm of the monitoring device, in aspects. As mentioned hereinabove, a monitoring device may include an alarm trigger point that is not readily visible to the clinician. Such trigger points may be factory-set or proprietary in nature, such that trigger points are not disclosed to clinicians, leaving the clinician “blind” as to when an alarm may be triggered and/or issue for a monitoring device of a patient. A triggering point might be a limit, threshold, or a range of measurements corresponding to a characteristic, such that when a monitoring device receives information that a patient's physiological or non-physiological characteristic is at (e.g., near, at, or exceeds) a triggering point, an alarm is triggered, and further, the alarm may issue a notification such as an audible, shrill beep emitted from the monitoring devices or communicating an electronic page message to a clinician responsible for the patient's care. Tuning might include increasing a threshold, decreasing a threshold, expanding a range, decreasing a range, adjusting an upper limit, adjusting a lower limit, resetting a limit or threshold, or a combination thereof. Tuning might include modifying a plurality of trigger points for one or more alarms of a patient. Tuning might further include modifying definitions of alarm factors such that a first limit might be defined as a triggering point for an urgent alarm, a second limit might be defined as a triggering point for a medium level alarm, and a third limit might be defined as a triggering point for a low level alarm. Tuning might include a one-step reset feature that enables a clinician to depress a button on a machine (e.g., physical button or electronic on-screen button) that indicates to the monitoring device that the current physiological measurement is a normal baseline for the patient and a limit, threshold, or range triggering point may be shifted accordingly. Tuning a monitor might be performed using an intelligent machine learning process, such that the monitoring device itself dynamically learns or determines a new baseline, or a normal baseline, for an individual patient based on a clinician's input (e.g., silencing an alarm) to alarm issuances over a period of time.

In the context of an action to be performed, undertaking an intervention refers to a clinician making an intervention on behalf of a patient. An intervention might include taking a medical or clinical action that addresses the physiological or non-physiological characteristic that triggered the alarm. An intervention might include performing a specified clinical protocol, calling a code, ordering a medical test, and/or ordering a medical consult with a particular medical service. In one example, when a high blood pressure measurement triggered the alarm, an indication to undertake an intervention to lower the patient's blood pressure may be provided to a clinician. The intervention may further include specific instructions such as “administer Lisinopril” or “check on patient,” for example. In another example, when an SPO2 measurement of zero triggers an alarm, an indication to undertake an intervention might include providing instructions such as “ensure sufficient contact of SPO2 sensor” or “SPO2 device adjustment is needed.” These intervention instructions are merely illustrative in nature and should not be construed as limiting as other medical instructions, including interventions that are tailored to a patient based on an electronic medical record, are considered to be within the scope of this invention.

At block 206, the method 200 includes communicating a notification of the alarm hotspot and the action to the clinician. In some aspects, the notification is visual, audial, or a combination thereof. In aspects, the communication is provided to the clinician in real time or near real time, such that the communication is provided close in time to the detection of the alarm hotspot, shown at block 202. In further aspects, the communication is provided to the clinician in real time or near real time, such that the communication is provided close in time to the performance of the analysis, shown at block 204. Thus, a notification of an alarm hotspot is presented to a clinician as events unfold throughout the day. This real-time presentation provides a clinician the opportunity to address an alarm hotspot during the day, as an alarm hotspot occurs. As such, a retroactive analysis or end-of-shift analysis is not needed. Instead, the notification acts as a real-time report when the notification is surfaced to the clinician. In some aspects, the communication of the notification of the alarm hotspot might be presented to the clinician before, during, or after presenting the action to the clinician. The notification may be communicated to a clinician as embedding in the clinician's normal workflow, in aspects. For example, a visual and/or audial notification such as an alert might be inserted into a clinician's electronically scheduled tasks that are accessed on a computing device, wherein the alert includes “follow-up on unit 401 for issuance of 20 alarms in the last hour” or “flagged unit 1212 for tachycardia alarm acceleration.” Additionally or alternatively, the notification may be communicated to a clinician using a wireless device such as a smartphone or a pager, in some aspects. For example, a visual notification such as “flagged for accelerating in most recent 15 minutes” might surface on a clinician phone. In another example, a visual notification of “unit 729 flagged—alarm limit” might surface at a clinician pager.

In yet another example, an audial notification is communicated to a clinician's mobile phone and issued from said mobile phone. In a further example, the audial notification is a specific tone or noise that is designated as indicating an alarm hotspot. In such an example, a physician may hear the specific tone indicating an alarm hotspot and recognize the audial notification immediately. Upon such recognition, the clinician may immediately take action to follow-up on the notification.

The visual and/or audial notification of the alarm hotspot is surfaced to the clinician in real time or near real time, independent of device used for presentation. The visual and/or audial notification may be communicated to one or more clinicians via specialized graphical user interfaces (GUIs), as discussed hereinafter. In some aspects, a visual notification is a graphics-based visualization of alarms, and alarm hotspots are presented on a GUI using a bar graph, a heat map, a bubble chart, a pie chart, or the like. In some aspects, an audial notification is presented concurrently with a visual notification via a GUI and speakers, for example.

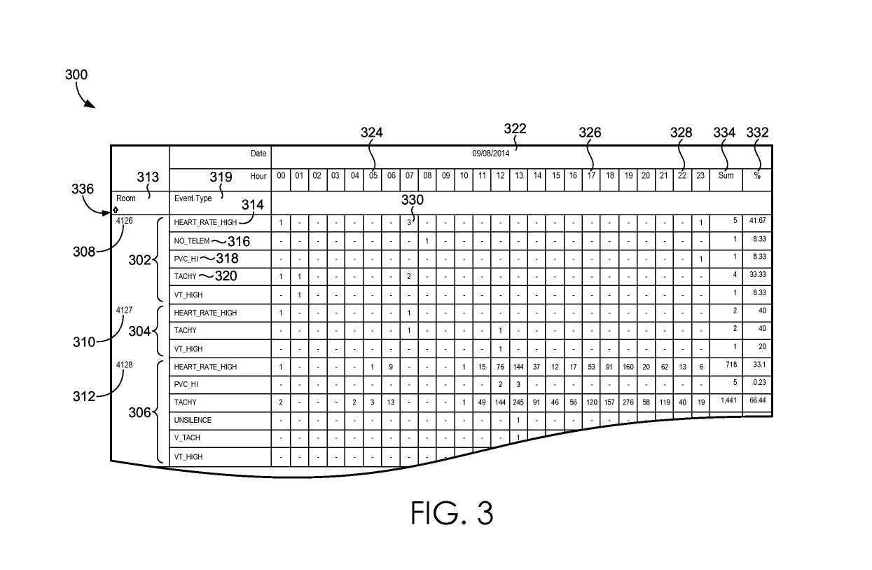

Turning now to FIG. 3, an exemplary graphical user interface (GUI) that displays a visual notification of alarms is provided for use in embodiments of the present invention. The graphical user interface 300 includes a plurality of rows and columns that organize a vast amount of patient information into an easily consumable informational display. Rows may be grouped together such that each group of rows 302, 304, and 306 corresponds to a facility room number 308, 310, and 312, shown in facility room column 313. Each facility room number 308, 310, and 312 may correspond to one or more patients assigned to a particular room in a facility such as a hospital, clinic, or treatment center. Each row with a group, such as group 302 for example, may include an event type identifier 314, 316, 318 and 320 that uniquely identifies a particular monitoring device that monitors a patient assigned to the corresponding facility room number 308. Each row therefore specifies one particular monitoring device that tracks a different physiological or non-physiological measurement of a patient. Event type identifiers may be found in the event type column 319. For example, a row includes the event type identifier 320 “TACHY” that corresponds to and identifies a monitoring device or monitoring devices that monitor physiological aspects that may indicate tachycardia is occurring or has occurred in the patient assigned to facility room 4126. In some embodiments a location of the GUI 300 may incorporate or include a patient identifier. Additionally, it will be understood by those skilled in the art that the use of rows and columns herein is merely illustrative such that other locations on a GUI other visualizations such as blocks, cells, lists, toolbars, buttons, icons, menus, diagrams and the like are contemplated to be within the scope of the invention. A location may refer to a specific or designated portion of a GUI to include specified information and/or a portion of pixels of the GUI corresponding to said location.

As shown in FIG. 3, a clinician may simultaneously view information for a plurality of different monitoring devices and a plurality of different facility rooms (e.g., each room corresponds to a different patient). The GUI 300 further includes a date identifier 322 and a plurality of hour indications 324, 326 and 328, for example, that simultaneously present alarm issuance information. The alarm issuance information may include the number of alarms that have issued over a time period. For example, three event type “HEART_RATE_HIGH” 314 alarms 330 issued during hour “07” on Sep. 8, 2014, in facility room 4126, as indicated in FIG. 3. Further, for the cumulative time period from hour “00” to hour “23,” the three event type “HEART_RATE_HIGH” 314 alarms 330 account for “41.67” of all alarms issued for the facility room 4126 as indicated in an aggregated percentage column 332. Further, an alarm summary column 334 indicates a summary of all alarms issued during a time period. For example, the alarm summary column 334 indicates that five event type “HEART_RATE_HIGH” 314 alarms issued, one event type “NO_TELEM” 316 alarm issued, one event type “PVC_HI” 318 alarm issued, four event type “TACHY” 320 alarms issued, and one event type “VT_HIGH” alarm issued during the twenty-four hour time period displayed for facility room 4126. In contrast, the alarm summary column 334 indicates that 718 event type “HEART_RATE_HIGH” alarms issued, five event type “PVC_HI” alarms issued, and 1,441 event type “TACHY” alarms issued during the twenty-four hour time period displayed for facility room 4128.

The GUI 300 may include sorting function capabilities that facilitate how information is displayed. For example, sorting indicator 336 may be engaged by a user in order to sort the facility room column. The sorting indicator 336 may be engaged by a user to toggle between displaying information sorted by ascending facility room number or descending facility room number, for example. When toggled, the groups of rows 302, 304, and 306 are also sorted according to a corresponding facility room number.

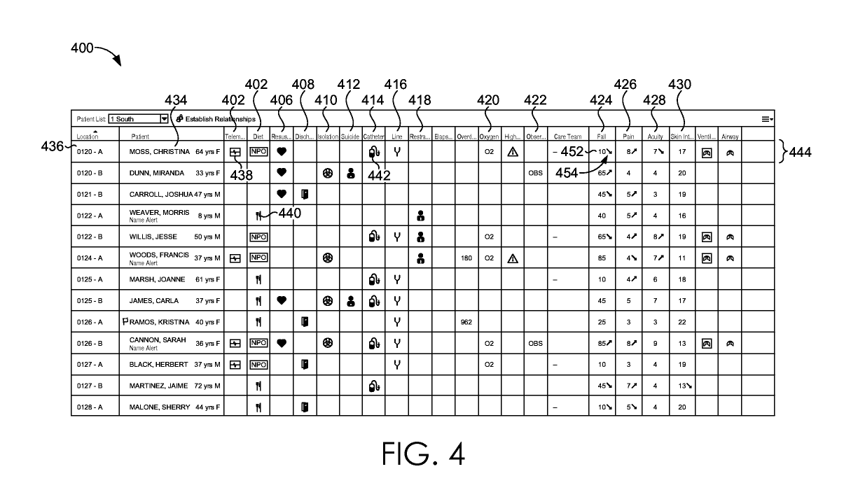

Referencing FIG. 4, an exemplary graphical user interface (GUI) that displays a visual notification of alarms is provided for use in embodiments of the present invention. At a high level, FIG. 4 includes an illustrative clinical leader dashboard display 400. The clinical leader dashboard display 400 may provide a plurality of rows, each corresponding to a particular patient. The clinical leader dashboard display 400 further includes a plurality of columns, each column may be used to indicate patient-specific information such as the presence or absence of: telemetry monitoring 402; dietary needs 404; resuscitation orders or restrictions 406; discharge instructions 408; isolation instructions 410; suicide watch 412; a catheter 414; a central line 416; physical restraints 418; an oxygen tank 420; observation instructions 422; fall risk 424; pain management 426; acuity 428; skin integrity 430 (e.g., skin ulcers); and a ventilator 432. For each patient, a visual indicator, such as an icon, may be placed in a column within a patient's corresponding row so as to indicate patient-specific information at a glance. Icons may be pictorially representative of the information (e.g., a lung-shaped icon may be used to indicate pulmonary-related information such as the presence of a ventilator). For example, a patient identifier 434 indicates that “Moss, Christina” is assigned to room “0120-A” as illustrated with the room identifier 436. Further, in this example, the patient “Moss, Christina” is currently being monitored according to the inclusion of a telemetry icon 438, has dietary instructions according to the presence of the diet icon 440, and has a catheter in place as indicated by the catheter icon 442, among other indicators shown in row 444 that represents the patient.

Continuing, the plurality of columns of the clinical leader dashboard display 400 may include one or more alarm-based columns (e.g., fall risk 426, pain management 426, and acuity 428) that register the issuance of one or more alarms, an event type of the one or more alarms, and changes in alarm issuance. In embodiments, the alarm-based columns may include an alarm hotspot indicator. The alarm hotspot indicator may notify a clinician of an alarm hotspot. In some embodiments, an alarm hotspot indicator may be displayed within one or more alarm-based columns having alarms corresponding to the alarm hotspot. The one or more alarm-based columns register alarm issuances and evaluate any changes in alarms in real time and automatically without intervention from a clinician. For example, the one or more alarm-based columns might include a fall risk column 424 to indicate an event type (e.g., a likelihood of a patient falling out of a hospital bed), indicate a number of alarms (e.g., ten alarms are indicated in a cell 452 under the fall risk column 424 for patient “Moss, Christina”) of the event type that have issued for a patient, and a trend indicator for the event type (e.g., trend indicator 454 is a downward pointing arrow). Further, the illustrative fall risk column 424 includes a trend indicator 454 for the event type that indicates a change in the alarm issuances associated with the event type. The trend indicator 454 may further be associated with an alarm hotspot, in some embodiments.

Generally, a trend indicator might indicate alarm acceleration or alarm deceleration based on alarm issuances for the patient. Alarm acceleration may be indicated with an upward angled arrow (e.g., arrow points upward) or other graphic indication of an increasing trend regarding an alarm. Alarm deceleration may be indicated with a downward angled arrow (e.g., arrow points downward) or other graphic indication of a decreasing trend regarding an alarm. The determination of alarm acceleration or alarm deceleration may be event-type specific, such that said determination results from thresholds, limits, ranges, and the like that are specific to the event type. As such, alarm deceleration of a fall risk might be determined differently than deceleration of skin integrity. As such, the issuance of an alarm and a trend for an alarm of a particular event type may be determined in a highly specialized manner. The trend indicator 454 may result from alarm acceleration such that the trend indicator 454 may be a precursor to an alarm hotspot, in some embodiments.

The indication of alarm issuances, such as “ten” in cell 452, as well as a trend indicator, such as trend indicator 454, may be selectable and/or interactive with a clinician. A clinician may use a mouse to click, or a touchscreen, to select the alarm hotspot of cell 452 and “drill-down” to receive more information regarding the alarm hotspot. For example, upon selection, a pop-up window with detailed alarm information for the event type “Fall Risk” for patient “Moss, Christina” may be presented to a clinician. In another example, upon selection, a clinician might be navigated to another screen or window where detailed alarm information regarding the event type “Fall Risk” for patient “Moss, Christina” may be presented to a clinician.

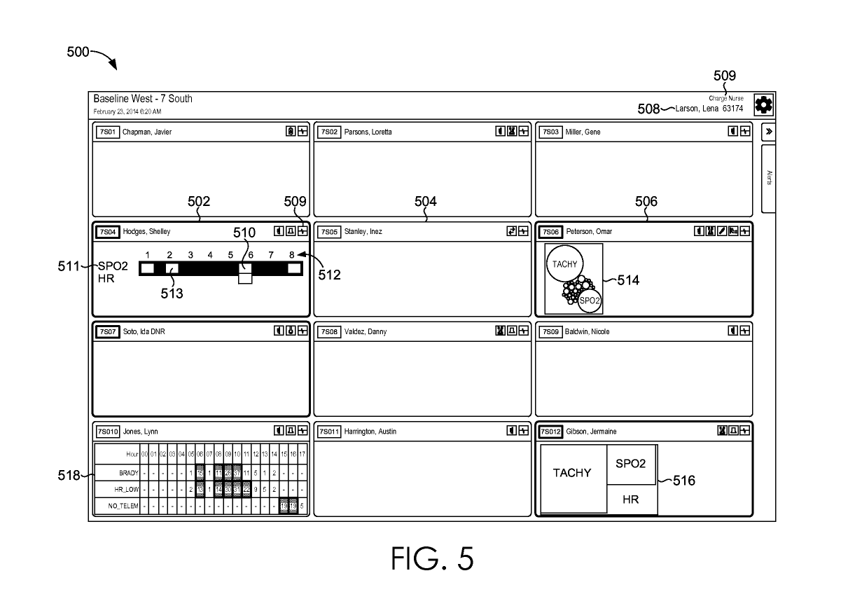

FIG. 5 provides an exemplary GUI that displays a visual notification of alarms. FIG. 5 includes an illustrative clinician summary view 500 for a plurality of patients. The clinician summary display 500 presents a summary for a plurality of cells 502, 504, and 506 corresponding to patients assigned to a particular clinician, such as “Charge Nurse” 509 “Larson, Lena” 508, for example. The clinician summary display 500 is clinician specific and includes those patients that are currently assigned to the clinician. The clinician summary display 500 may include patients assigned to the clinician on a particular shift, day, week, or other time period. The summary display 500 includes indications of patient-specific information for each of the plurality of patients. For example, cell 502 indicates a patient identifier of “Hodges, Shelley.” The cell 502 may include an indicator of the active telemetry monitoring 509, or other pictorial representations, similar to those discussed regarding FIG. 4, in some aspects. In cell 502, a visual notification 511 of an alarm hotspot is presented with regard to the patient identified as “Hodges, Shelley.” The visual notification 511 identifies at least one specific physiological characteristic of the patient, here SPO2 and HR (e.g., heart rate). The visual notification 506 further illustrates alarm hotspots 510 and 513, for example, using a heat map. The heat map representation of the alarm hotspot indicates an alarm hotspot associated with the colors white, for example, and the absence of an alarm hotspot associated with the color black. Further, the heat map representation of the alarm hotspots includes hour increments 512 to indicate alarm issuance and alarm information for specific periods of time. Additional visual notifications of alarm hotspots include visual notifications 514, 516, and 518, which may function similarly so as to produce at-a-glance alarm information for respectively identified patients “Peterson, Omar;” “Gibson, Jermaine;” and “Jones, Lynn,” each assigned to “Larson, Lena” 508, who presumably has the employment position of “Charge Nurse” 509.

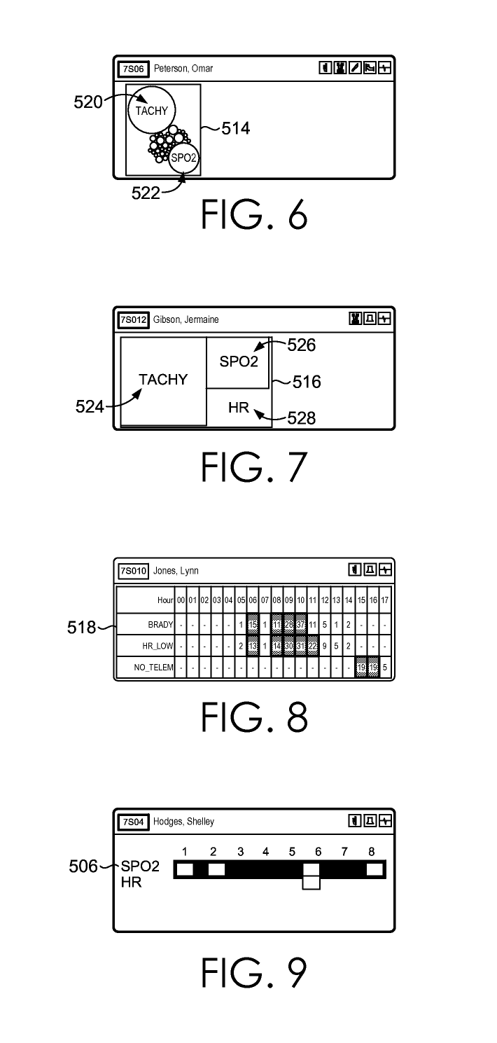

With reference to FIGS. 6-9, detailed views of exemplary visual notifications for alarm hotspots for patients are provided, based on the GUI of FIG. 5. FIG. 6 presents a first variation of a visual notification 514 of an alarm hotspot occurring in a one hour time period, more specifically, the most recent one hour period. The illustrative variation includes a bubble chart, wherein the size of a bubble indicates importance of a particular alarm of a monitoring device relative to any other alarms for the patient in which the bubble chart is located. For example, for patient identified as “Peterson, Omar” and assigned to facility room number “7S06,” the bubble identified as “Tachy” 520 is presented as larger in size than the bubble identified as “SPO2” 522, thus indicating that more alarms (or at least one more urgent alarm) for tachycardia-monitoring device(s) have issued in comparison to one or more alarms for SPO2-monitoring device(s). And as alarm information is updated in real time, the size of the bubbles in the bubble chart may fluctuate in size in real time, as presented on a GUI.

FIG. 7 presents a second variation of a visual notification 516 of an alarm. In FIG. 7, a block chart 516 is presented wherein the size of a block indicates importance of a particular alarm of a monitoring device relative to any other alarms for the patient in which the block chart is located. The block chart 516 presents a summary of alarm information for the most recent one hour time period, in embodiments. In another aspect, the block chart 516 presents alarm information for the previous four hours. The time periods discussed herein may be configured to present a default period of time, may reflect any number of hours or days, may be modified based on a clinician's preference, and thus are presented herein as examples only.

For example, for patient identified as “Gibson, Jermaine” and assigned to facility room number “7S012,” the block 524 identified as “Tachy” is presented as larger in size than the block 526 identified as “SPO2,” thus indicating that the “Tachy” alarms are determined to be, based on the complex determination of an alarm hotspot discussed above, more relevant or more important at the time of presenting the visual notification for tachycardia-monitoring device(s) than alarms corresponding to an SPO2-monitoring device(s). As shown, all alarm blocks may be shown together within the boundary of the whole block chart 516 that represents 100% of all monitoring devices and/or alarms that are currently being used to monitor a patient. The visual notification (e.g., block chart 516) therefore presents a relative importance of an alarm relative to other alarms, as well as a representation of the percentage or share accounted from by each alarm.

FIG. 8 presents a third variation of a visual notification 518 of alarms and alarm hotspots, similar to FIG. 1, as discussed above. The visual notification 518 is a timeline type view that presents several previous hours, up to 24 hours, for example. FIG. 9 presents a fourth variation of a visual notification 506 of an alarm that includes a heat map. The heat map may represent the concentration of alarm issuances for each event type, relative alarm importance for each event type presented together, and/or alarm issuance frequency, for example. Similar to FIG. 8, the visual notification 506 of FIG. 9 is a timeline type view that simultaneously presents alarm information for several previous hours. A timeline type view may be beneficial for providing recent, historical patient alarm data to a clinician.

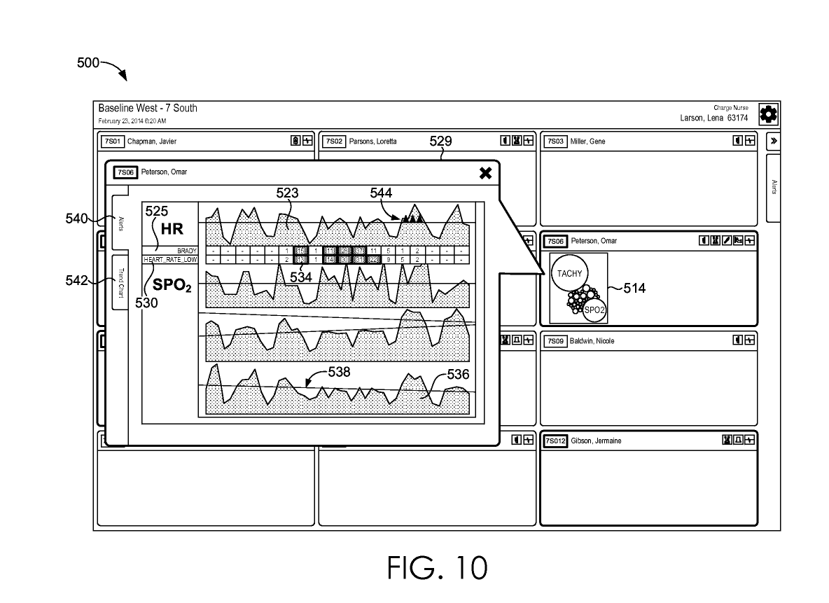

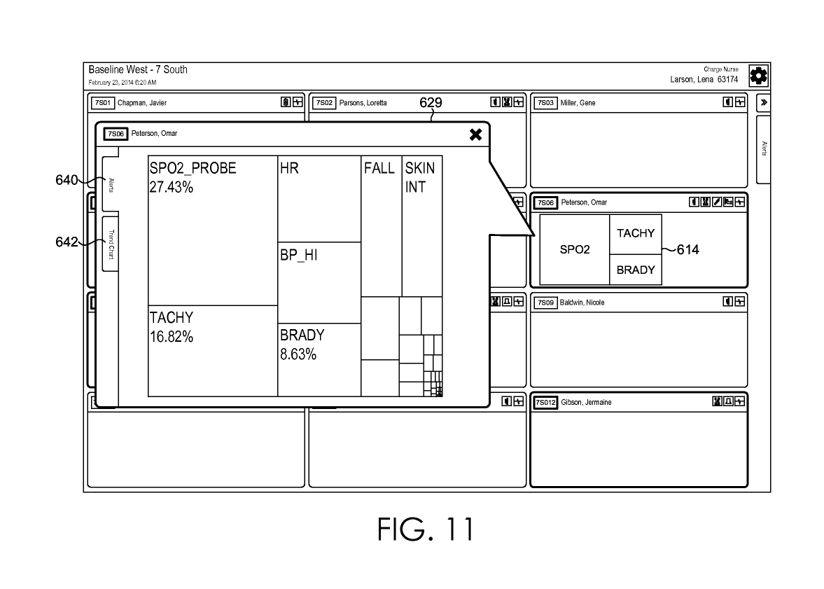

FIGS. 10-11 provide exemplary GUIs that display visual notifications of alarms. More specifically, FIG. 10 presents a drill-down pop-up window 529 based on the GUI of FIG. 5. The drill-down pop-up window 529 is displayed in response to selection of the visual notification 514. In some aspects and as illustrated in FIG. 10, the drill-down pop-up window 529 may overlay a summary display such as summary display 500, with or without variable transparency. A clinician might select the visual notification 514 by hovering a mouse over the visual notification 514, by clicking anywhere in the region and/or boundaries of the display of the visual notification 514, and/or by using a touchscreen to tap, slide, swipe, pinch, or zoom gesture, in some aspects. The drill-down pop-up window 529 generally presents details and additional information regarding the one or more alarms or alarm hotspots represented in the visual notification 514. For example, measurements of a patient's heart rate may be simultaneously presented as a graph 526, as a table 528 reporting on bradycardia alarms (e.g., “Brady”) and corresponding bradycardia alarm hotspots and/or as a table 530 reporting low heart rate alarms and alarm hotspots 534, all presented within the drill-down pop-up window 529 when the bubble chart 514 has been selected. The alarm hotspots 534 presented in the table 528 may include visual enhancements that visually attract the attention of a clinician, including attractive and/or contrasting colors, flashing outlines or colors, stationary and visually distinguishably outlining or highlighting, gradient shading, and the like. In the drill-down pop-up window 529, physiological measurements regarding SPO2 might further be simultaneously presented in response to selection of the visual notification 514. For example, a graph 536 is presented that indicates a plurality of SPO2 measurements received from at least one monitoring device of the patient over a period of time. The presentation of detailed SPO2 information may be presented because monitoring devices that correspond to SPO2 levels have issued and account for a significant percentage of all alarms issued for a patient. Accordingly, the drill-down pop-up window 529 may present alarm and alarm hotspot information that is determined to be the most important, most urgent, most recent, and/or according to a sequence or ranking. Additionally or alternatively, the presentation of SPO2 information may be presented because SPO2 levels may be diagnostically relevant to the heart rate information presented. In further aspects, a trend line may be included in a chart, such as trend line 538 that indicates an identified change pattern or trend in the measurements (e.g., an average of SPO2 levels might be decreasing over a time period, for example). The drill-down pop-up window 529 may further include tabs that may be engaged to reveal additional information, including alarms and alarm hotspots. Exemplary tabs may include tab “Alert” 540 and tab “Trend Chart” 542. Additionally, one or more alarm issuances may be indicated with one or more icons 544. The icons may represent a measurement of particular interest and, as such, are visually noted in order to notify the clinician of the one or more alarm issuances of interest.

FIG. 11 also presents a second exemplary drill-down pop-up window 629 based on the GUI of FIG. 5. The drill-down pop-up window 629 is displayed in response to selection of the visual notification 614. In some aspects and as previously described with reference to FIG. 10, the second drill-down pop-up window 629 may overlay a summary display in response to clinician selection (e.g., hovering a mouse over the visual notification, clicking on the visual notification, tapping a touchscreen). The second drill-down pop-up window 629 displays detailed, patient-specific alarm and alarm hotspot information that corresponds to the visual notification 614. The second drill-down pop-up window 629 includes a detailed block chart 631 that provides alarm hotspot information including a percentage of alarm issuances for various characteristics as measured by monitoring devices. The percentages shown are examples only, and the complex analysis and alarm hotspot determinations previously described herein may result in complicated weighting and ratio-based determinations such that different alarm issuances and relative importance or urgency thereof are represented in a meaningful and intelligent manner, resulting in a more complex and robust visual notification. For example, the percentages may not correspond to the mere number of alarm issuances (e.g., 20 alarm issuances of 100 total alarm issuances amounts to 8%), but rather, may account for weighting, event type (e.g., some event types may be weighted differently than others), a level of emergency, severity of an alarm issuance, time sensitivity, alarm acceleration, alarm deceleration, frequency of alarm issuances, how recently an alarm issued, and/or the like, as have been described herein.

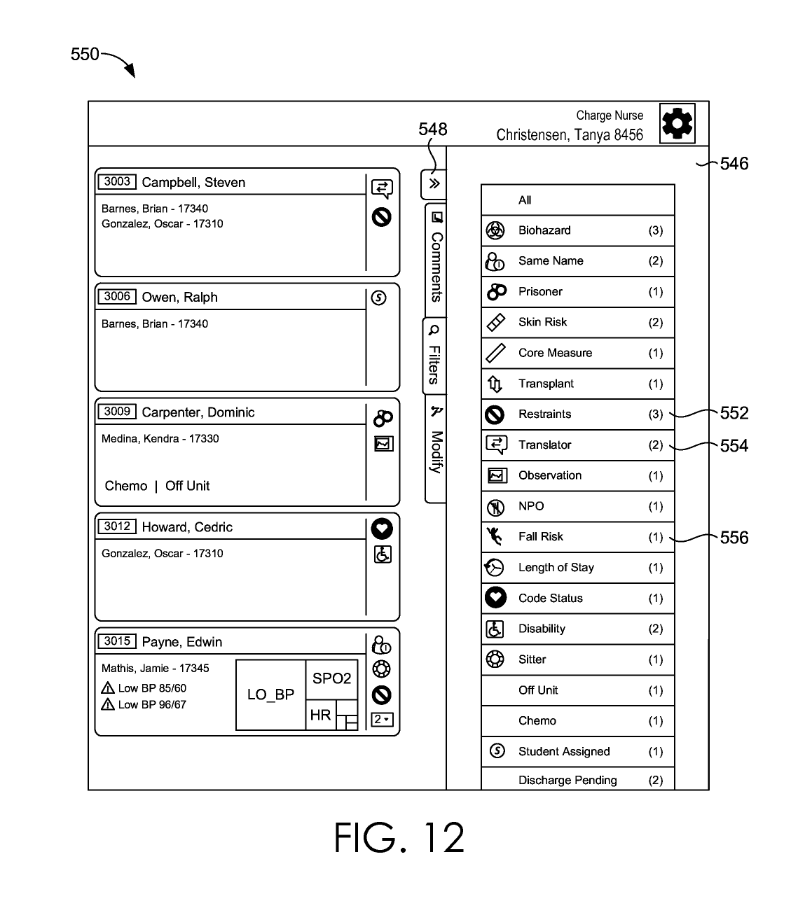

FIG. 12 provides a portion of an exemplary GUI that displays a visual notification of alarms. More specifically, FIG. 12 presents a portion of a summary type GUI 550 that includes a sidebar 546 in addition to summary patient cells. By engaging a reveal tab 548, the sidebar 546 may be revealed or displayed fully on the GUI 550. The reveal tab 548 facilitates toggling between revealing the sidebar 546 and hiding the sidebar 546 from view on the GUI 550. The sidebar 546 may be graphically minimized, similar to the GUI 500 illustrated in FIG. 5, for example. When a clinician engages the reveal tab 548, the sidebar 546 is revealed on the GUI 550 in order to provide further function and information. The sidebar 546 may provide a clinician the ability to view a summary that represents alarm information for all of the patients assigned to that clinician. Accordingly, a clinician is notified, at a glance, that three patients assigned to that same clinician are indicated as having or needing restraints 552, two patients assigned to that same clinician are indicated as needing a translator 554, and one patient assigned to that same clinician is indicated as associated with a fall risk 556 and/or a fall risk alarm. Further pictorial representations of this information may also be displayed in patient cells of the summary type view 550.

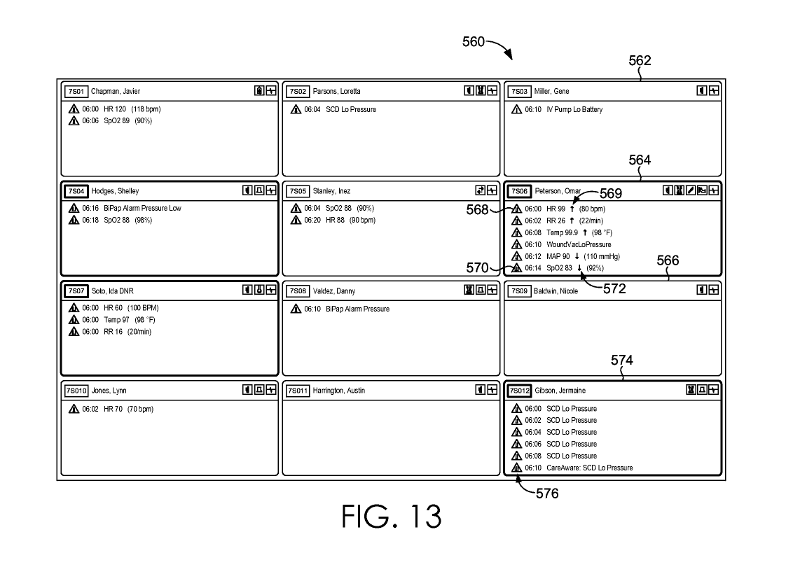

Referencing FIG. 13, a GUI is provided that displays a visual notification of alarms. FIG. 13 includes an alert summary display 560. The alert summary display 560 includes a plurality of patient-specific cells, such as 562, 564, and 566 which include patient-specific alert information for patients identified as “Miller, Gene;” “Peterson, Omar;” and “Baldwin, Nicole,” in patient-specific cells 562, 564, and 566, respectively. Regarding illustrative patient-specific cell 564, a plurality of alerts is displayed. One or more of the alerts may include an alarm and/or an alarm hotspot. For example, alert 568 indicates that at time 06:00 hours, the patient's heart rate (e.g., HR 99) was elevated at 80 beats per minute (bpm). The alert 568 may be provided to a clinician in real time as a response to the issuance of an alarm for a monitoring device that tracks the patient's heart rate. The alert 568 includes a trend indicator 569 of an upward pointing arrow that is an easily consumable visual representation of an increase regarding the characteristic of the patient that is relevant to the alert. In another example, alert 570 indicates that at time 06:14, the patient's SPO2 levels dropped, as shown with a trend indicator 572 of a downward pointing arrow. For each patient-specific cell, alerts may further be presented together in chronological order, such that the most recent alert is presented at the top of an alert list. Alternatively, alerts may be presented in reverse chronological order such that the oldest alert is presented at the top of an alert list.

In patient-specific cell 574, a series of alerts directed to sequential compression device pressure (SCD Lo Pressure) are displayed. Each alert displayed generally corresponds to an alarm issuance at time points 06:00, 06:02, 06:04, 06:06, and 06:08, respectively. The alert is generated in real time, and the time points generally correspond to the real-time alarm issuance from at least one monitoring device that, here, monitors SCD Pressure. The series of alerts is determined to comprise an alarm hotspot, as shown in FIG. 13. An alarm hotspot alert 576 is generated in response to the determination that the series of alerts comprises an alarm hotspot. The alarm hotspot alert 576 is generated and displayed on the GUI 560 in real time.

Further still, patient-specific cells (e.g., facility room 7S06 shown as cell 564; facility room 7S012 shown as cell 574) have an outline that is larger, bolder, and/or highlighted, for example, in a way that draws visual attention to those cells. The cells include visual enhancements that serve as a secondary type of visual notification of an alarm hotspot regarding alarms associated with the patients that correspond to the cells. As shown, an alert may include an alert icon with “!”, “!!”, or “!!!” to indicate an alert severity and/or urgency. In aspects, the more “!” present in an alert icon, the more severe and/or urgent the alarm hotspot. The alarm hotspot might include an indication to change a patient lead, tune an alarm setting on a monitoring device, and/or undertake an action that addresses the alarm and the characteristic corresponding to the monitoring device.

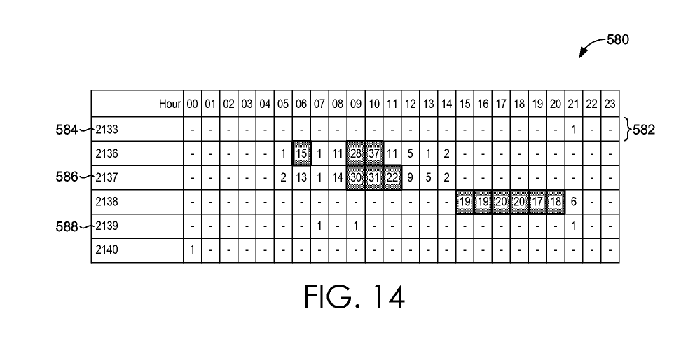

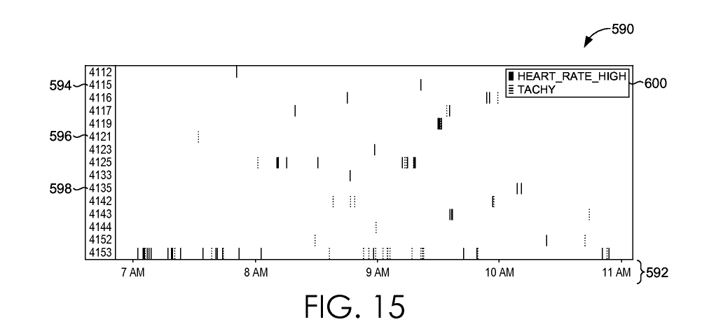

Turning now to FIGS. 14 and 15, exemplary GUIs that display a visual notification of alarms are provided. FIGS. 14 and 15 are each directed to a unit-level alarm summary display. FIG. 14 includes a table type GUI 580 having a timeline 582 that includes hourly increments and facility room indicators such as 584, 586, and 588, for example. FIG. 15 includes a ladder chart GUI 590 having at timeline 592 that includes hourly increments and facility room indicators such as 594, 596, and 598, for example. The ladder chart GUI 590 also includes a key 600 that can be used by a clinician to visually distinguish a first event type alarm issuance from a second event type alarm issuance. For example, a high heart rate alarm is indicated with a solid bar whereas a tachycardia alarm is indicated by a broken or dashed bar. A unit-level view may be useful for hospital evaluations and auditing purposes. And a unit-level view may improve identification, tracking, and responses to alarm hotspots within a given hospital unit, medical service, or the like. The unit-level views indicated in FIGS. 14 and 15 generate an easily consumable visual notification of alarms and alarm hotspots. The alarm indicators in FIGS. 14 and 15 may be selectable, such that a drill-down pop-up window is produced to provide additional clinical detail to the clinician.

The present invention has been described in relation to particular embodiments, which are intended in all respects to be illustrative rather than restrictive. Further, the present invention is not limited to these embodiments, but variations and modifications may be made without departing from the scope of the present invention.

What is claimed is:

1. A computer-implemented method for generating visual or audible alarm notifications at a clinician endpoint in real time, the method comprising:
for each of a plurality of patients:
detecting an alarm hotspot, wherein an alarm hotspot includes one or more indications of a monitor alarm issuance;
analyzing the alarm hotspot in near-real time; and
communicating, in near-real time, a notification of the alarm hotspot to the clinician, wherein the notification indicates one or more changing a lead, tuning a monitor alarm limit, and an intervention, are available to the clinician.

2. The method of claim 1, wherein detecting an alarm hotspot further comprises:
aggregating monitor alarm issuance information using the one or more indications of the monitor alarm issuances.

3. The method of claim 1, wherein detecting an alarm hotspot further comprises:
determining that the one or more indications of monitor alarm issuances qualify as an alarm hotspot based on two or more of:
a number of monitor alarm issuances;
the duration of alarm issuances;
a monitor alarm severity indication;
a monitor alarm urgency indication; and
a defined time period.

4. The method of claim 1, wherein detecting an alarm hotspot further comprises:
determining there is alarm acceleration based on the one or more indications.

5. The method of claim 1, wherein analyzing the alarm hotspot in real time to identify an action to be performed by a clinician further comprises:
determining that at least one of the one or more indications of the monitor alarm issuances has an increased likelihood of resulting from a data artifact, wherein the data artifact is an inaccurate reading from a monitoring device.

6. The method of claim 1, wherein analyzing the alarm hotspot in near-real time to identify an action to be performed by a clinician further comprises:
determining at least one alarm setting of a monitoring device is not tuned with specificity to an individual patient.

7. The method of claim 6, wherein analyzing the alarm hotspot in real time to identify an action to be performed by a clinician further comprises:
determining a first modified setting of the at least one alarm setting of the monitoring device, such that the first modified setting is tuned with specificity to an individual patient.

8. A graphical user interface (GUI) for presenting a clinician dashboard with visual alarm notifications for a plurality of patients, the GUI comprising:
a patient list including a plurality of patients assigned to a medical service, a clinician, or both;
a location having an alarm notification that indicates an alarm issuance specific to a device, wherein the device measures patient data and wherein the alarm notification, as presented, is automatically updated in near-real time; and
when it is determined that the alarm issuance specific to the device qualifies as an alarm hotspot, an alarm hotspot notification that indicates the alarm hotspot is automatically generated for presentation to the clinician at the location.

9. The graphical user interface of claim 8, further comprising:
at the location, the real-time alarm notification that provides an indication of alarm issuances specific to a device includes a visual enhancement that indicates that the alarm issuances are determined to be an alarm hotspot.

10. The graphical user interface of claim 8, further comprising:
a second location corresponding to the patient list, such that an identifier for each of the plurality of patients monitored by the clinician is presented at the second location.

11. The graphical user interface of claim 8, wherein the real-time alarm notification is selectable, and when the real-time alarm notification is selected, the GUI further includes:
a pop-up window that presents detailed alarm visualizations.

12. The graphical user interface of claim 8, further comprising:
within the location, a near-real-time trend indicator is presented adjacent to the indication of alarm issuances specific to the device, wherein the real-time trend indicator indicates alarm acceleration or alarm deceleration of the device.

13. The graphical user interface of claim 12, wherein the real-time trend indicator is selectable, and when the real-time trend indicator is selected, the GUI includes:
a pop-up window that presents detailed alarm trend information.

14. A graphical user interface (GUI) for presenting alarm visualizations to a clinician in real time regarding a plurality of patients, comprising:
a plurality of cells, each cell including a location indicator and a patient indicator, each cell being specific to one patient that corresponds to the patient indicator, the patient being assigned to the same medical unit; and
when a determination of an alarm hotspot is made regarding the patient, the cell corresponding to the patient further includes an alarm hotspot visualization representing at least one monitor alarm issuance specific to the patient, wherein the alarm hotspot visualization is a representation of a timeline of the alarm hotspot or a representation of a most recent time interval of the alarm hotspot.

15. The graphical user interface of claim 14, wherein the alarm hotspot visualization is a bubble chart, block chart, ladder chart, graph, or table that updates in real time to reflect one or more alarms triggered for the patient.

16. The graphical user interface of claim 14, wherein the alarm hotspot visualization includes an alert icon that indicates a severity level of the alarm hotspot.

17. The graphical user interface of claim 14, further comprising:
within the at least one column, a real-time trend indicator is presented adjacent to the indication of monitor alarm issuances specific to the first monitor, wherein the real-time trend indicator indicates alarm acceleration or alarm deceleration of the first monitor.

18. The graphical user interface of claim 17, wherein the real-time trend indicator is selectable, and when the real-time trend indicator is selected, the GUI includes:
a pop-up window that presents detailed alarm trends information.

19. The graphical user interface of claim 18, wherein the alarm hotspot visualization is selectable such that in response to selection, a drill-down detail window is presented that includes detailed alarm hotspot information.

20. The graphical user interface of claim 19, wherein the drill-down detail window simultaneously presents patient-specific information for more than one alarm hotspot.
